(19) United States
(12) Patent Application Publication
(10) Pub. No.: US 2003/0133265 A1
(43) Pub. Date: Jul. 17, 2003

(54) Thermal energy recovery system for electrical equipment

(75) Inventors: Kenneth L. Kinsey, Austin, TX (US); Cory A. Williams, Austin, TX (US); Louis A. Dye JR., Austin, TX (US); Joseph O. Duhon, Austin, TX (US); Nicholas A. Botello, Dripping Springs, TX (US); Paul H. Ellis, Austin, TX (US); Colin B. Ellis, Austin, TX (US)

Correspondence Address: HUGHES & LUCE LLP, 1717 MAIN STREET, SUITE 2800, DALLAS, TX, 75201, US

(73) Assignee: Protractive Systems, Inc., Austin, TX

(21) Appl. No.: 10/346,220

(22) Filed: Jan. 17, 2003

Related U.S. Application Data
(60) Provisional application No. 60/349,709, filed on Jan. 17, 2002.

(51) Int. Cl. G06F 1/20

(52) U.S. Cl. 361/687; 361/695

(57) ABSTRACT

The present invention provides more effective cooling than conventional cooling systems through the use of forced air flow over system components, accomplishing this without requiring supplemental energy used by the system. The system generates energy through the Hall turbine, which is then returned to the power supply for use by the computer's components.

### RELATED APPLICATIONS

This application claims the benefit of, priority to and incorporates by reference U.S. Provisional Patent Application Serial No. 60/349,709 filed to inventors Kinsey, et al. and entitled “Energy Recovery System for Electrical Equipment.”

### TECHNICAL FIELD OF THE INVENTION

The present invention relates generally to all electrical systems and methods where heat is generated as a by-product of the operations of electrical components. More specifically, the present invention may be applied to computers (mainframe, PC and laptop) to recapture energy lost as heat, thus re-cycling the energy for use by the host system.

### BACKGROUND OF THE INVENTION

Certain laptop computers presently have cooling systems that use circulating fluid pumps and special forced-air venting. This cooling process consumes precious energy, better suited for computing tasks. More importantly, this energy expenditure reduces the amount of time the device can run between charges. Limitations of present battery technologies necessitate the conservation of power and the most efficient use of existing reserves for computing functions. Increasing this efficiency improves overall performance of portable computing systems such as laptop computers.

A need exists for a thermal energy recovery system to return lost energy for use as electrical energy.

A further need exists to more efficiently remove excess heat from operating environment of electrical components, thus improving the overall performance of individual components. The ability to store a portion of this previously lost energy to the working components in the form of electricity provides further incentive.

### SUMMARY OF THE INVENTION

This invention was developed in the context of computing systems, but could be applied to any electrical system with components which release energy as heat and have components which rotate about an axis as part of their normal operations.

The present invention provides a thermal and magnetic energy capture and return system for electronic systems such as computers. The present invention additionally provides a more efficient means for removing heat from electronic systems that previously wasted energy to the system for future use. By increasing overall efficiency and recovering previously lost energy, the present invention reduces disadvantages associated with previously developed cooling systems and methods used for cooling computers.

Another embodiment of the present invention system ensures proper cooling of secondary components and converts the resulting thermal energy (hot air) into electrical energy for use by the system. This system includes a fan coupled to disk drive shaft, wherein the fan circulates air through ducting within the computing device. A turbine coupled to the ducting is driven by air circulating to generate electrical energy. A power distribution system receives and/or stores the electrical energy. The system may further include a processor thermally coupled to a thermal electric heat sink, wherein the thermal electric heat sink generates electrical energy. The system may additionally thermally couple the thermal electric heat sink to the ducting to naturally circulate air within the computing device.

Another embodiment may include additional disk drives, wherein these additional disk drive couples via a shared shaft to a generator coupled to the power distribution system. Alternatively, a motor-generator can be used to drive the disk drive or convert the angular kinetic energy associated with the drive to electrical energy.

The present invention provides a more efficient means for cooling electronic components that comprises ducting that cools the entire system.

The present invention provides another technical advantage by providing a loss-free method for driving hot air out of the system. (drive fans)

The present invention provides yet another technical advantage by returning lost energy to the system as electrical energy with a hall turbine and centrifical fan.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates one embodiment of the present invention that reduces operating temperatures and recovers thermal energy for use by the device as applied within a computing device;

FIG. 2 depicts the temperature control unit within FIG. 1;

FIGS. 3A and 3B depict the thermoelectric processor and heat sink within FIG. 1;

FIG. 4 shows the Hard Drive Centrifical Fan;

FIGS. 5A, 5B, and 5C depict the Hall Turbine, compressor and bearing;

FIG. 6 illustrates one embodiment of a battery within FIGS. 1, 2 and 3;

FIG. 7 provides an electrical circuit diagram of a DC power supply; and

FIG. 8 provides an electrical circuit diagram of a battery charger.

### DETAILED DESCRIPTION OF THE INVENTION

Preferred embodiments of the present invention are illustrated in the FIGURES, like numerals being used to refer to like and corresponding parts of the various drawings.

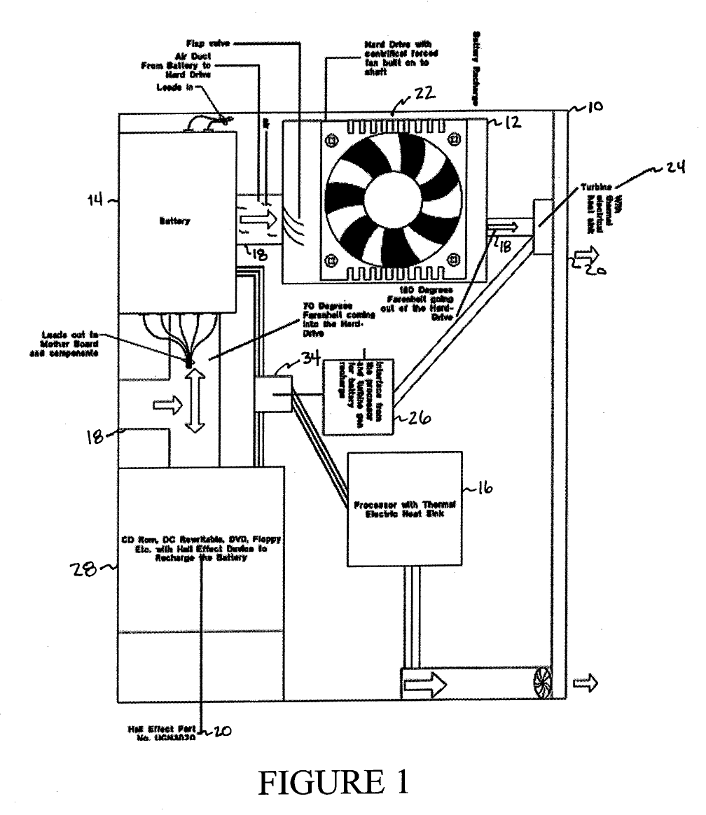

The present invention provides a thermal energy recovery system for electronic equipment for which one embodiment is illustrated in FIG. 1.

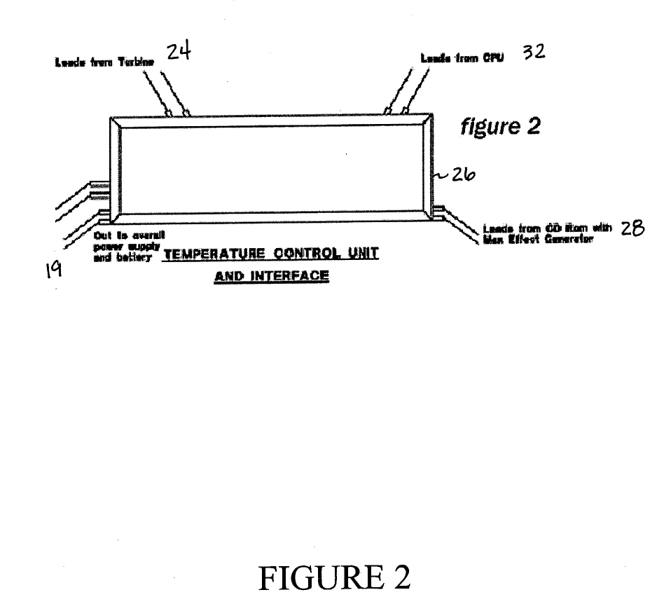

FIGS. 2-5 depict individual component parts.

The thermal energy recovery system provided by the present invention removes heat from operating components of an electrical system, such as a computer, and converts a portion of the lost thermal energy to electrical energy.

As previously stated, FIG. 1 illustrates one embodiment of the present invention. The embodiment shown here reduces operating temperatures and generates energy for use by the device as applied to a computer motherboard 10. Electronic devices generate heat within motherboard 10. Such electronic devices include hard drive 12, batter or power supply 14, processor 16 and/or motherboard 10. Here the heat is captured by ducting 18 and thermal energy recovery devices 20. Warm air driven by fan 22 Hall centrifugal hard drive passes through Hall Turbine 24. Fan 22 as shown comprises a Hall Centrifical Hard Drive Fan. Forced-air cooling provided by air moving through ducting 18 provides targeted cooling to electronic devices and motherboard 10, thus extending component life and increasing efficient operation. Hall turbine 24 converts the air driven by fan 22 into electrical energy that may be immediately used or stored for future use. Temperature Control Unit 26 regulates whether this energy is stored for future use or immediately used.

FIG. 2 depicts Temperature Control Unit (TCU) 26. TCU 26 provides system control for cooling and energy recovery. TCU 26 connects to and provides interface/control functions for CD drive 28 with Max Effect Generator 30, the CPU thermal heat sink 32, Hall Turbine 24, Exhaust fan 22 and the Power Supply Battery 14.

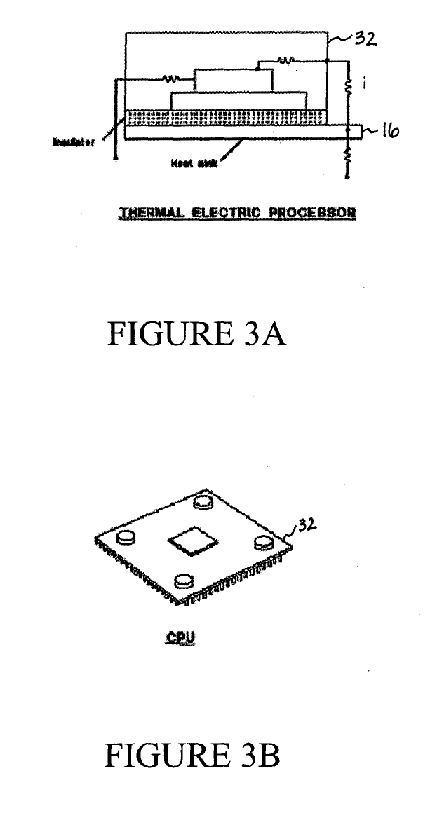

FIGS. 3A and 3B depict the Processor 32 and Heat Sink 16. This unit can be added in place of a standard heat sink, or integrated into the processor design. This unit draws heat away from processor, thereby providing direct cooling of the unit. The Thermo-Electric Processor and Heat Sink converts this heat into electrical energy, which is routed to controller 34 (shown in FIG. 1). Controller 34 directs the electrical energy to immediate use or to charge the battery 14. The Processor Thermo-Electric heat sink ducts directly out of the unit using a separate exhaust fan associated with turbine 24.

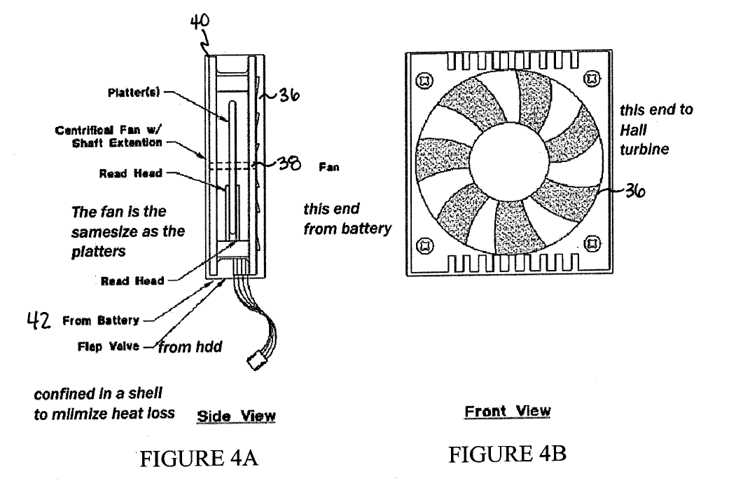

FIGS. 4A and 4B illustrate the Hard Drive Centrifical Fan 22. Centrifical fan 36 as shown mounts on drive shaft 38 of hard drive 40. A CD, DVD, floppy or other such drive may be used. Centrifical fan 36 provides cooling for drive 40 forcing air through the system to the Hall Turbine 24. Generated electrical energy using Hall Effect Generator 24 is routed to the controller 34. Flapper valve 42 prevents reverse airflow within the fan.

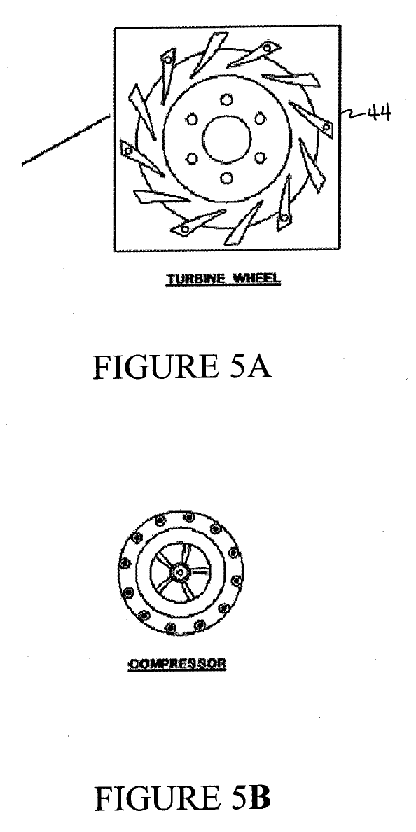

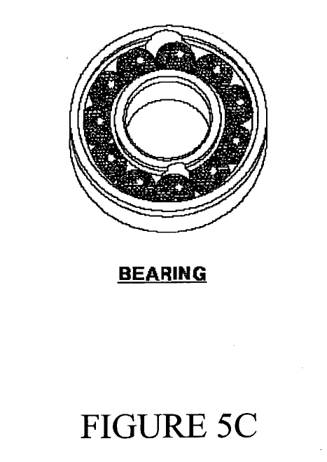

FIG. 5A depicts Hall Turbine 24. Warm air vented from a computer drives Hall Turbine 24 to generate electrical energy. The energy is routed by Temperature Control Unit 26 through a controller 34 to the power supply. Before entering turbine wheel 44, air passes through compressor 46 (shown in FIG. 5B). FIG. 5C depicts a bearing, which absorbs thrust from the compressor.

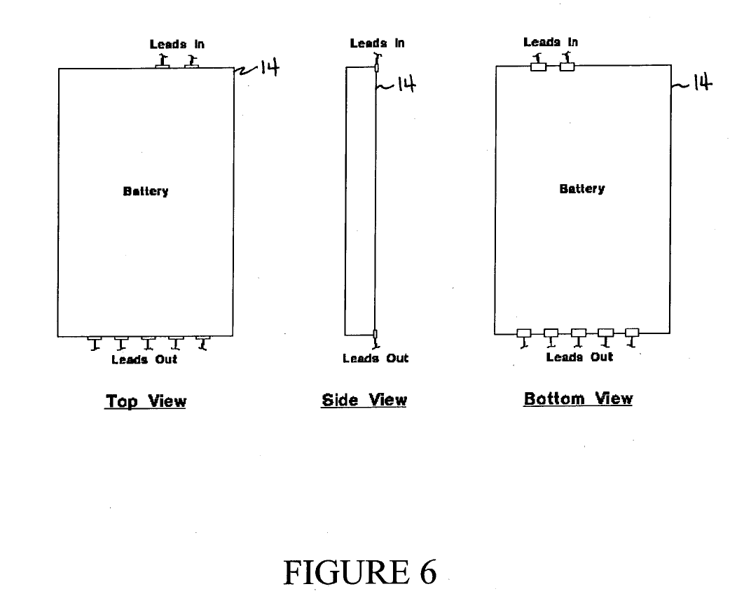

FIG. 6 provides various views of battery 14 located within motherboard 10.

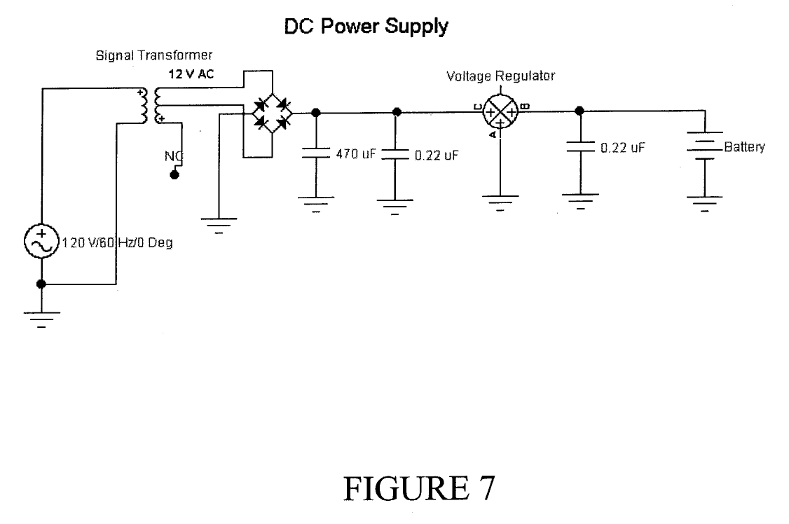

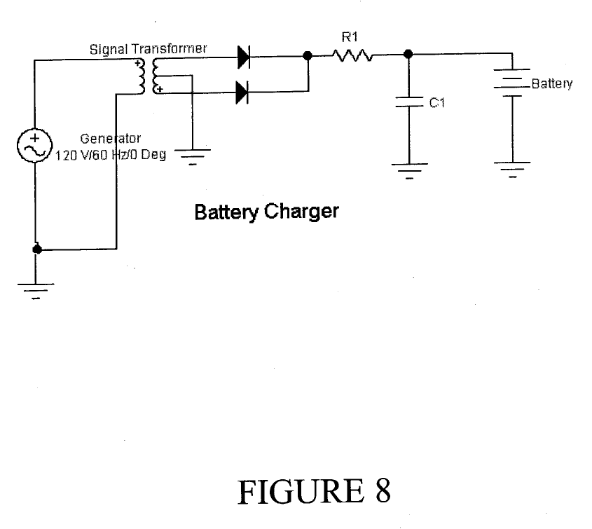

FIGS. 7 and 8 provide circuit diagrams of the power supply and battery charger, respectively.

In operation, the present invention removes heat from electrical devices, ensuring a proper operating environment, in a way that preserves system power, and returns energy to the system. The present invention in one embodiment ducts airflow to ensure cooling of devices through focused airflow, while protecting other components from heat generated by ducted devices.

Centrifical Fan force airflow through the system, to both cool components and drive the Hall Turbine. The unique advantages to this system are that it accomplishes component cooling and turbine drive through the normal operation of hard drive components. The present invention also recovers previously wasted energy with the Thermal Electric Processor and heat sink. The thermal electric processor and heat sink work in conjunction with the ducting system to improve airflow and cooling over conventional systems, as well as converting thermal energy directly into electrical energy. These systems couple to a TCU which provides system interface and control of component operations, ensuring proper component temperatures, as well as regulating the flow of energy to the power supply and/or battery.

The present invention provides an innovative, yet highly scalable means to convert thermal energy into electrical energy for immediate or future use.

Other embodiments include Hall Effect Generator for CD ROM. The Hall Effect Generator for CD ROM converts magnetic energy into electrical energy. This energy is then routed through the controllers as previously discussed.

In summary, the present invention provides a Thermal Energy Recovery System for Electronic Equipment that provides more effective cooling of computer system components and converts the resulting thermal energy (hot air) into electrical energy for use by the system.

The present invention provides more effective cooling than conventional cooling systems with forced airflow over system components, accomplishing this without requiring supplemental energy used by the system. The system generates energy through the Hall turbine, which is then returned to the power supply for use by the computer's components.

Although the present invention is described in detail, it should be understood that various changes, substitutions and alterations can be made hereto without departing from the spirit and scope of the invention as described by the appended claims.

What is claimed is:

1. A system for cooling electronic components within a computing device, comprising:
a-fan coupled to disk drive shaft, wherein said fan circulates air through ducting within the computing device;
a turbine coupled to said ducting, wherein circulating air drives said turbine to generate electrical energy; and
a power distribution system to receive and/or store said electrical energy.

2. The system of claim 1, wherein said power distribution system comprises a battery to store said electrical energy.

3. The system of claim 2, wherein said power distribution system regulates charging said battery.

4. The system of claim 3, wherein said power distribution system provides a trickle charge to said battery.

5. The system of claim 1, further comprising a processor thermally coupled to a thermal electric heat sink, wherein said thermal electric heat sink generates electrical energy.

6. The system of claim 5, wherein said thermal electric heat sink thermally couples to said ducting to naturally circulate air within the computing device.

7. The system of claim 1, wherein the computing device comprises at least one additional disk drive, wherein said at least one additional disk drive couples via a shared shaft to a generator coupled to said power distribution system and wherein said generator generates electrical energy.

8. The system of claim 1, wherein the computing device comprises at least one additional disk drive having a motor-generator coupled to said power distribution system, wherein said motor-generator converts kinetic energy to electrical energy as said disk drive slows.

9. A system for cooling electronic components within a computing device, comprising:
a fan coupled to disk drive shaft, wherein said fan circulates air through ducting within the computing device;
a processor thermally coupled to a thermal electric heat sink, wherein said thermal electric heat sink generates electrical energy, and wherein said thermal electric heat sink thermally couples to said ducting to naturally circulate air within the computing device.
a turbine coupled to said ducting, wherein circulating air drives said turbine to generate electrical energy; and
a power distribution system to receive and/or store said electrical energy.

10. The system of claim 9, wherein said power distribution system comprises a battery to store said electrical energy.

11. The system of claim 10, wherein said power distribution system regulates charging said battery.

12. The system of claim 11, wherein said power distribution system provides a trickle charge to said battery.

13. The system of claim 9, wherein the computing device comprises at least one additional disk drive, wherein said at least one additional disk drive couples via a shared shaft to a generator coupled to said power distribution system and wherein said generator generates electrical energy.

14. The system of claim 9, wherein the computing device comprises at least one additional disk drive having a motor-generator coupled to said power distribution system, wherein said motor-generator converts kinetic energy to electrical energy as said disk drive slows.

15. The system of claim 9, wherein said computing device comprises a laptop computer.

16. The system of claim 9, wherein said disk drive comprises a hard-drive, floppy drive, cd drive or dvd drive.

17. The system of claim 14, wherein said at least one additional disk drive comprises a hard-drive, floppy drive, cd drive or dvd drive.

18. A method of cooling electronic components within a computing device, comprising:
circulating air through ducting within the computing device with a fan coupled to a disk drive shaft;
generating electrical energy with a turbine coupled to said ducting, wherein circulating air drives said turbine; and
receiving and/or storing said electrical energy within a power distribution system.

19. The method of claim 18, further comprising generating electrical energy with a thermal electric heat sink thermally coupled to a processor.

20. The method of claim 18, further comprising naturally circulating air within the computing device by thermally coupling said ducting to a processor heat sink.
